(19) United States
(12) Patent Application Publication
(10) Pub. No.: US 2022/0314495 A1
(43) Pub. Date: Oct. 6, 2022

(54) Fiber-Reinforced Thermoplastic Laminate

(71) Applicant: Tanso, Inc., Oakland, CA (US)

(72) Inventor: Hemant Bheda, Saratoga, CA (US)

(73) Assignee: Tanso, Inc., Oakland, CA (US)

(21) Appl. No.: 17/693,346

(22) Filed: Mar. 12, 2022

Related U.S. Application Data
(60) Provisional application No. 63/170,095, filed on Apr. 2, 2021.

(51) Int. Cl. B29B 11/16; B32B 1/00; B32B 5/26; B32B 27/12; B32B 27/08; B32B 37/18; B32B 38/00

(52) U.S. Cl. CPC B29B 11/16; B32B 1/00; B32B 5/26; B32B 27/12; B32B 27/08; B32B 37/182; B32B 38/0004; B32B 2398/20

(57) ABSTRACT

A fiber-reinforced thermoplastic laminate is disclosed that comprises continuous reinforcing fiber. The laminate is custom designed and fabricated to be molded into a specific article of manufacture. The laminate comprises a plurality of thermoplastic patches that are disjoint and some of which partially overlap.

### CROSS-REFERENCE TO RELATED APPLICATIONS

This application claims the benefit of U.S. Patent Application Ser. No. 63/170,095 (Attorney Docket 5011-002pr1), which is incorporated by reference in its entirety.

U.S. patent application Ser. No. 17/669,999 (Attorney Docket 5011-001us1) is incorporated by reference in its entirety.

U.S. Patent Application Ser. No. 63/149,263, (Attorney Docket 5011-001pr1) is incorporated by reference in its entirety.

### FIELD OF THE INVENTION

The present invention relates to composite manufacturing in general, and, to fiber-reinforced thermoplastic laminates that are used for thermoforming in particular.

### BACKGROUND OF THE INVENTION

A popular method of manufacturing involves:
(1) heating a sheet of thermoplastic until it is pliable,
(2) using a vacuum to force the plastic to stretch and conform to a mold, and
(3) cooling the plastic so that it permanently assumes the shape of the mold.
   In general, this method of manufacturing is called “thermoforming.”

In some cases, the sheet comprises one layer of thermoplastic, but in other cases the sheet comprises two or more layers of thermoplastic and reinforcing fiber. When the sheet comprises two or more layers of thermoplastic and reinforcing fiber, it is called a “fiber-reinforced thermoplastic laminate.” Fiber-reinforced thermoplastic laminates are sometimes known as “organo sheets” or “RTL's.”

### SUMMARY OF THE INVENTION

Some embodiments of the present invention enable the fabrication of an article of manufacture from a fiber-reinforced thermoplastic laminate without some of the costs and disadvantages for doing so in the prior art.

In general, there are two types of reinforcing fiber in a fiber-reinforced thermoplastic laminate: “continuous fiber” and “chopped fiber.” In general:
(i) continuous fiber is much longer than chopped fiber, and
(ii) the directional orientation of continuous fiber is carefully controlled—so that adjacent fibers are parallel or follow a related curve, whereas the directional orientation of chopped fiber is haphazard or random, and
(iii) continuous fiber adds more strength and stiffness to the finished article of manufacture than chopped fiber.

The inclusion of chopped fiber in a laminate generally does not cause complications during thermoforming, but the inclusion of continuous fiber does. In some cases, the inclusion of continuous fiber in a laminate prevents the laminate from properly deforming and assuming the shape of the mold. The illustrative embodiment addresses this issue by thermoforming a fully-custom fiber-reinforced thermoplastic laminate that comprises two or more layers of:
(i) one or more patches of fiber-reinforced thermoplastic, or
(ii) a full sheet of unreinforced thermoplastic, or
(iii) one or more patches of unreinforced thermoplastic, or
(iv) one or more patches of reinforcing fiber without thermoplastic, or
(v) one or more metal and/or plastic structural inserts, or
(vi) any combination of i, ii, iii, iv, and v.

In accordance with the illustrative embodiment, a non-planar article of manufacture is designed that is to be thermoformed or otherwise molded from a fiber-reinforced thermoplastic laminate. As part of the design process, an engineer considers:
(i) the desired utility of the article; and
(ii) the desired aesthetics of the article (e.g., surface finish, etc.); and
(iii) the desired physical (e.g., structural, thermal, electromagnetic, etc.) attributes of the article; and
(iv) the desired material and production costs to fabricate the article
   in order to produce:
(a) a complete specification of the required geometry of the article; and
(b) a complete specification of the physical (e.g., structural, thermal, electromagnetic, etc.) requirements of the article; and
(c) a complete specification of the economic requirements for fabricating the article; and
(d) a complete specification of the post-processing requirements of the article.

After the article is designed, the engineer must consider the question of what laminate should be used to fabricate the article. Although there are many different fiber-reinforced thermoplastic laminates that are commercially available off-the-shelf, some articles cannot be made from them. The article of manufacture shown in FIGS. 2a, 2b, 2c, and 2d, and described in the Detailed Description is one of them.

Therefore, in accordance with the illustrative embodiment, an engineer next produces a fully-custom design for a fiber-reinforced thermoplastic laminate from which the article can be fabricated.

As part of this task, the engineer considers:
(i) the required geometry of the article in general, and, in particular, how the different portions of the laminate must stretch and be displaced to conform to the contour of the mold; and
(ii) the physical requirements of the article in general, and, in particular, whether the laminate will satisfy the physical requirements of the article after the laminate has been stretched and deformed; and
(iii) the economic requirements of the article; and
(iv) the post-processing requirements of the article
   to produce a complete specification of the laminate, which includes, among other things:
(i) a description of the overall dimensions of the laminate; and
(ii) a description of the number of layers that will compose the laminate; and
(iii) a description of whether each layer comprises:
   a full sheet of thermoplastic embedded with reinforcing fiber, or
   a full sheet of thermoplastic without reinforcing fiber, or
   a full sheet of reinforcing fiber without thermoplastic, or
   one or more patches of thermoplastic embedded with reinforcing fiber, or
   one or more patches of thermoplastic without reinforcing fiber, or
   one or more patches of reinforcing fiber without thermoplastic, or
   one or more metallic or plastic structural inserts.
(iv) a description of the overall dimensions and relative location of each piece in each layer; and
(v) for each piece that comprises a thermoplastic, a description of which thermoplastic(s) will compose that layer; and
(vi) for each piece that comprises reinforcing fiber, a description of the chemical makeup of the reinforcing fiber (e.g., carbon, glass, aramid, hemp, etc.); and
(vii) for each piece that comprises reinforcing fiber, a description of whether the reinforcing fiber are continuous or chopped; and
(viii) for each piece that comprises reinforcing fiber, a description of the number or density of the fibers; and
(ix) for each piece that comprises continuous reinforcing fiber, a description of whether the reinforcing fiber are unidirectional or multidirectional; and
(x) for each piece that comprises continuous reinforcing fiber, a description of the angular orientation of the fibers; and
(xi) for each piece that comprises continuous reinforcing fiber, a description of whether any continuous fibers are to be severed; and if so where the cuts should be; and
(xii) for each metallic or plastic structural insert, a description of its size, shape, location, and material composition.

In accordance with the illustrative embodiment, the laminate is designed to comprise five layers:
(1) a bottom layer that is a full sheet of thermoplastic without reinforcing fiber, and
(2) a second layer that that comprises six patches of fiber-reinforced thermoplastic (as shown in FIG. 7), and
(3) a third layer that comprises four metallic ring segments (as shown in FIG. 8), and
(4) a fourth layer that comprises nine patches of fiber-reinforced thermoplastic (as shown in FIG. 9), and
(5) a fifth layer that is a full sheet of thermoplastic without reinforcing fiber.

The absence of a full sheet of fiber-reinforced thermoplastic ensures that the laminate deforms and conforms to the contours of the mold during thermoforming, but the inclusion of patches of fiber-reinforced thermoplastic enables the article to have better structural characteristics than if they were not present.

The relative position of the patches and inserts in the laminate relative to the contours of the mold must be precisely aligned, and, therefore, the engineer adds two corresponding registration marks to the top of the laminate and to the clamping frame. This facilitates the precise positioning of the laminate with the mold when the laminate is positioned in the clamping frame prior to heating and molding.

After the laminate is designed, an engineer next designs a mold, clamping frame, and post-processing dies, in well-known fashion. Afterwards, the mold, clamping frame, and post-processing dies are fabricated, also in well-known fashion.

Next, the laminate is fabricated. The sheets and patches are cut and assembled into the layup, and then the layup is heated and consolidated into the laminate. Lastly the registration marks are added to the top of the laminate.

Next the laminate is clamped in the clamping frame while using the registration marks to precisely align the cuts in the laminate with the clamping frame, whose location to the mold is precisely controlled. Then the laminate is heated, deformed by the mold (either male or female) with the assistance of a vacuum and ambient air pressure, and allowed to cool and harden.

Lastly, the article is removed from the mold and post-processed in well-known fashion.

### BRIEF DESCRIPTION OF THE DRAWINGS

FIG. 1 depicts a flowchart of the salient tasks associated with the illustrative embodiment of the present invention.

FIG. 2a depicts an orthographic top view of cover 200, drawn to scale, as shown.

FIG. 2b depicts an orthographic front view of cover 200, drawn to scale as shown.

FIG. 2c depicts an orthographic side view of cover 200, drawn to scale as shown.

FIG. 2d depicts an isometric perspective drawing of cover 200.

FIG. 3 depicts a flowchart of the salient tasks associated with task 102—designing the fiber-reinforced thermoplastic laminate from which cover 200 will be fabricated.

FIG. 4a depicts an orthographic top view of first candidate laminate 400, drawn to scale, as shown.

FIG. 4b depicts an orthographic front view of first candidate laminate 400, drawn to scale as shown.

FIG. 5 depicts a schematic composition of the logical layers that compose first candidate laminate 400

FIG. 6 depicts an orthographic top view of laminate layer 501.

FIG. 7 depicts an orthographic top view of laminate layer 502, which depicts the shape, location, and orientation of each of the six patches.

FIG. 8 depicts an orthographic top view of laminate layer 503, which depicts the shape and location of the four segments.

FIG. 9 depicts an orthographic top view of laminate layer 504, which depicts the shape, location, and orientation of each of the nine patches.

FIG. 10 depicts an orthographic top view of laminate layer 505.

FIG. 11 depicts a flowchart of the salient subtasks associated with task 104—fabricating the fiber-reinforced thermoplastic laminate.

FIG. 12a depicts a flowchart of the orthogonal front view of mold 1200, which is a male mold.

FIG. 12b depicts a flowchart of the orthogonal side view of mold 1200.

FIG. 12c depicts a flowchart of the orthogonal side view of mold 1200.

### DEFINITIONS

Article—For the purposes of this specification, the word “article” and its inflected forms is defined to be a synonym of an “article of manufacture.”

Full Sheet—For the purposes of this specification, a “full sheet” of fiber-reinforced thermoplastic, unreinforced thermoplastic, or fiber reinforcement without thermoplastic is defined as having a footprint equal to or greater than the footprint of the fiber-reinforced thermoplastic laminate.

Laminate—For the purposes of this specification, the word “laminate” and its inflected forms is defined to be a synonym of “fiber-reinforced thermoplastic laminate.”

Patch—For the purposes of this specification, a “patch” of fiber-reinforced thermoplastic, unreinforced thermoplastic, or fiber reinforcement without thermoplastic is defined as having a footprint less than the footprint of the fiber-reinforced thermoplastic laminate.

RTL— For the purposes of this specification, the initialism “RTL” and its inflected forms is defined to be a synonym of “fiber-reinforced thermoplastic laminate.”

### DETAILED DESCRIPTION

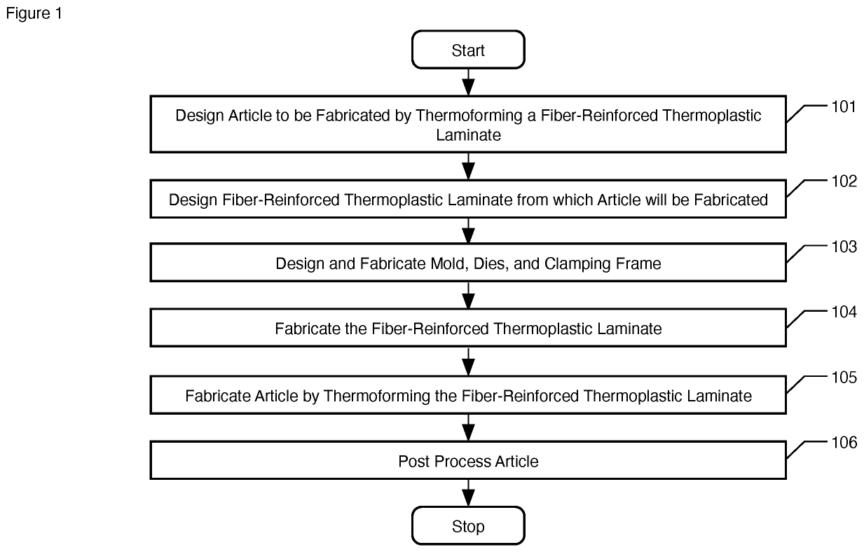

FIG. 1 depicts a flowchart of the salient tasks associated with the illustrative embodiment of the present invention.

At task 101, an engineer with the assistance of a computer-aided design system designs an article of manufacture that is to be fabricated by thermoforming a fiber-reinforced thermoplastic laminate. As part of task 101 the engineer considers:
(i) the desired utility of the article; and
(ii) the desired aesthetics of the article; and
(iii) the desired physical (e.g., structural, thermal, electromagnetic, etc.) attributes of the article; and
(iv) the desired material and production costs to fabricate the article
   in order to produce:
(a) a complete specification of the required geometry of the article; and
(b) a complete specification of the physical (e.g., structural, thermal, electromagnetic, etc.) requirements of the article; and
(c) a complete specification of the economic requirements for fabricating the article; and
(d) a complete specification of the post-processing requirements of the article.
   In accordance with the illustrative embodiment, the article is the cover for a machine—cover 200. It will be clear to those skilled in the art, after reading this disclosure, how to make and use alternative embodiments of the present invention that fabricate a different article.

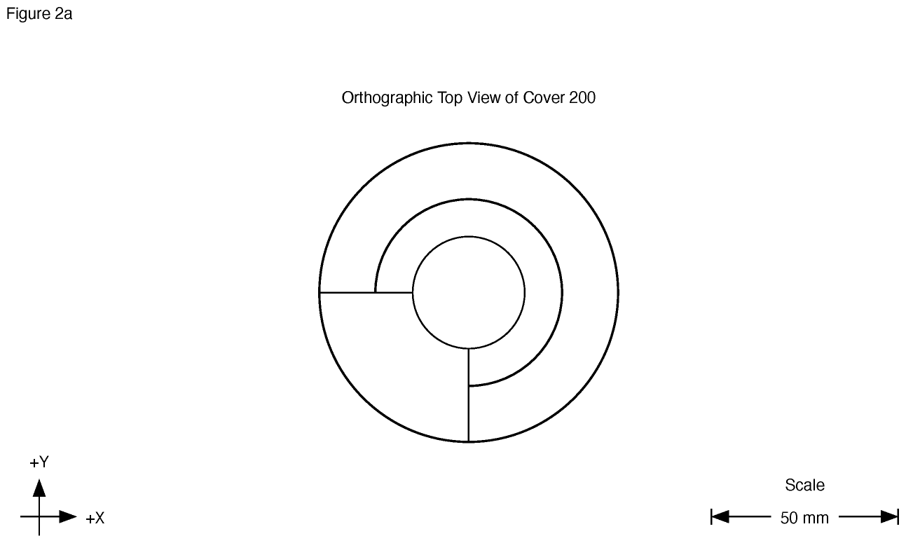

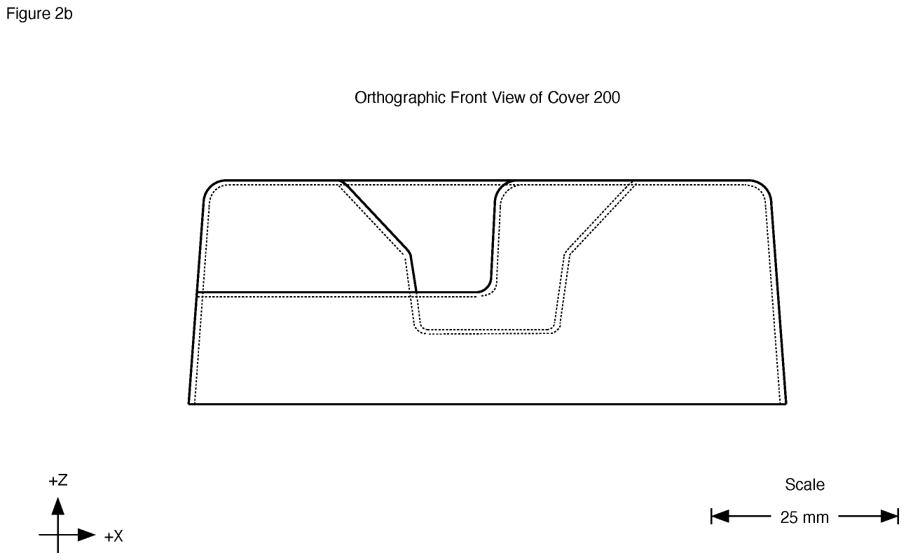

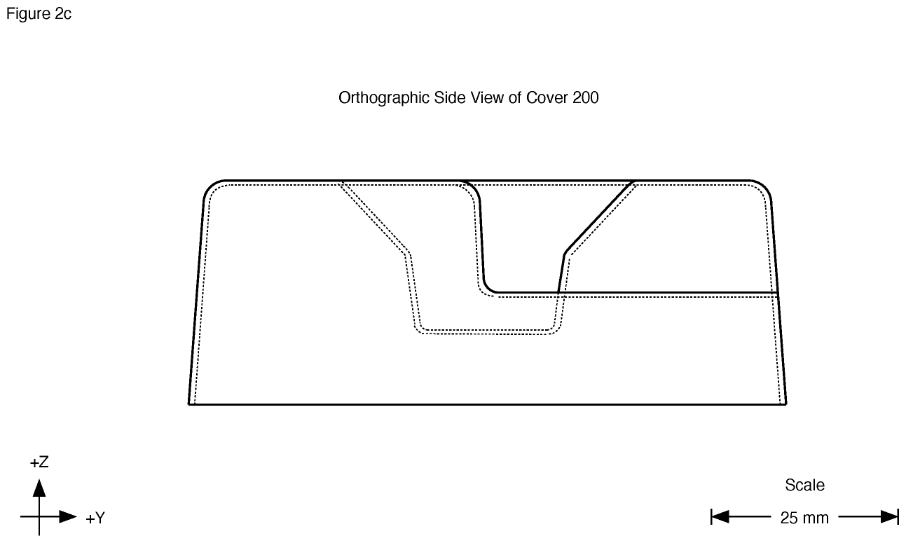

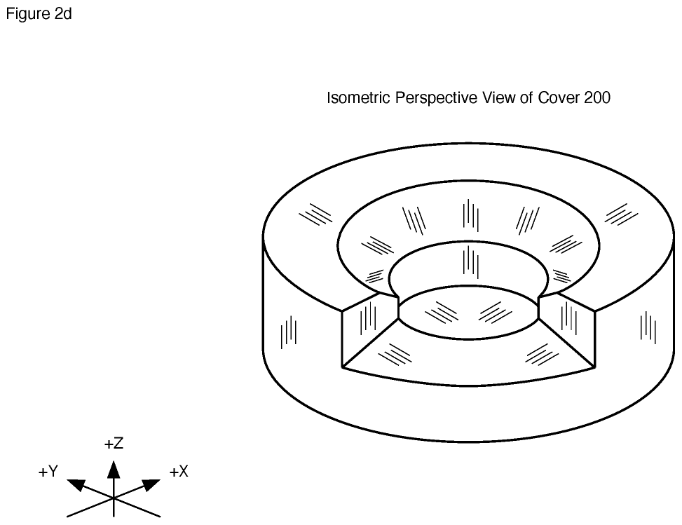

In accordance with the illustrative embodiment, the complete specification of the required geometry of cover is given in FIGS. 2a, 2b, and 2c, which depict orthographic top, front, and side views, respectively, of cover 200. FIG. 2d depicts an isometric perspective drawing of cover 200.

Cover 200 is 80.0 (Δx) by 80.0 mm (Δy) by 60.0 mm (Δz). The salient features of cover 200 are a concave depression (when viewed from the top) and a depressed shoulder in one quadrant. It will be clear to those skilled in the art, after reading this disclosure, how to make and use alternative embodiments of the present invention that have any required geometry.

In accordance with the illustrative embodiment, the complete specification of the physical requirements of cover 200 comprises a detailed specification of the structural properties (e.g., tensile strength, compressive strength, stiffness, modulus, etc.) of each portion of cover 200. It will be clear to those skilled in the art, after reading this disclosure, how to make and use alternative embodiments of the present invention that have any physical requirements.

In accordance with the illustrative embodiment, the complete specification of the post-processing requirements of cover 200 comprises a requirement that the base be die cut from the square laminate from which it is formed, and that the top side of cover 200 be sanded and painted. It will be clear to those skilled in the art, after reading this disclosure, how to make and use alternative embodiments of the present invention that have any post-processing requirements.

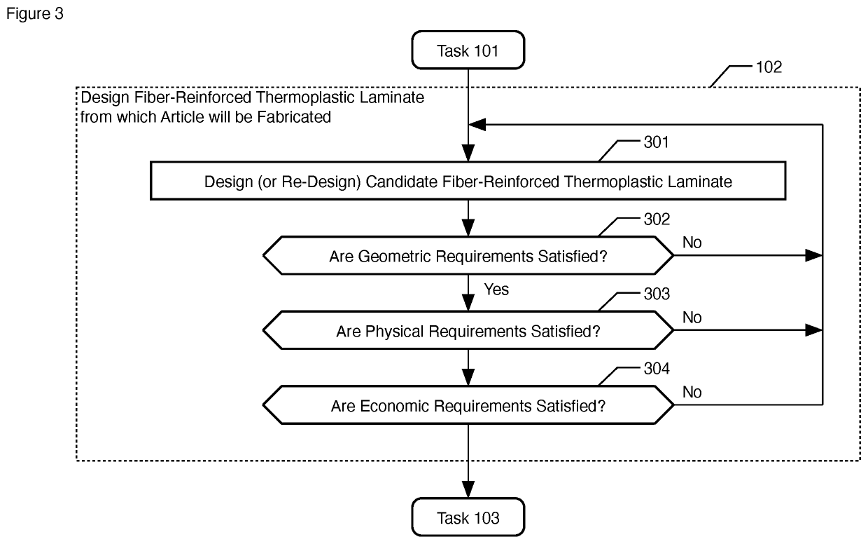

At task 102, the engineer designs a custom fiber-reinforced thermoplastic laminate from which cover 200 will be thermoformed. Task 102 is described in detail in FIG. 3 and the accompanying text.

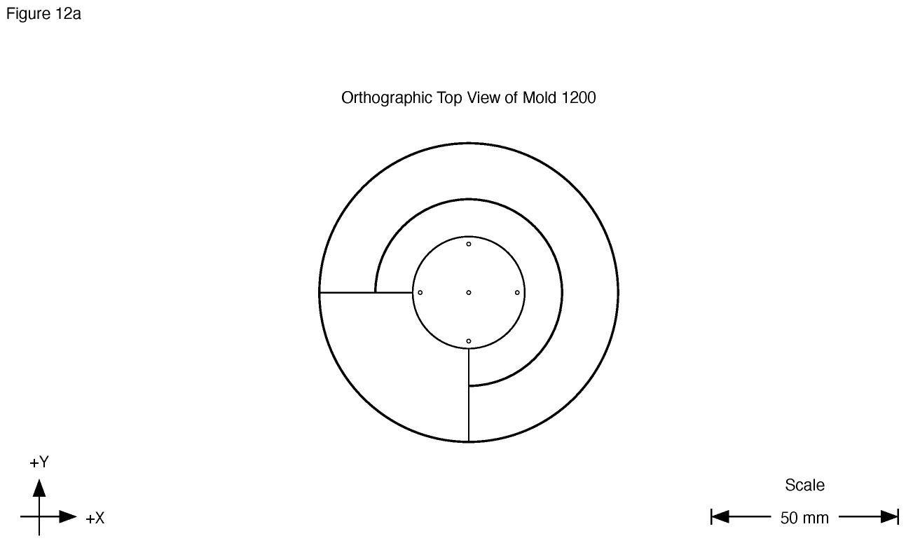

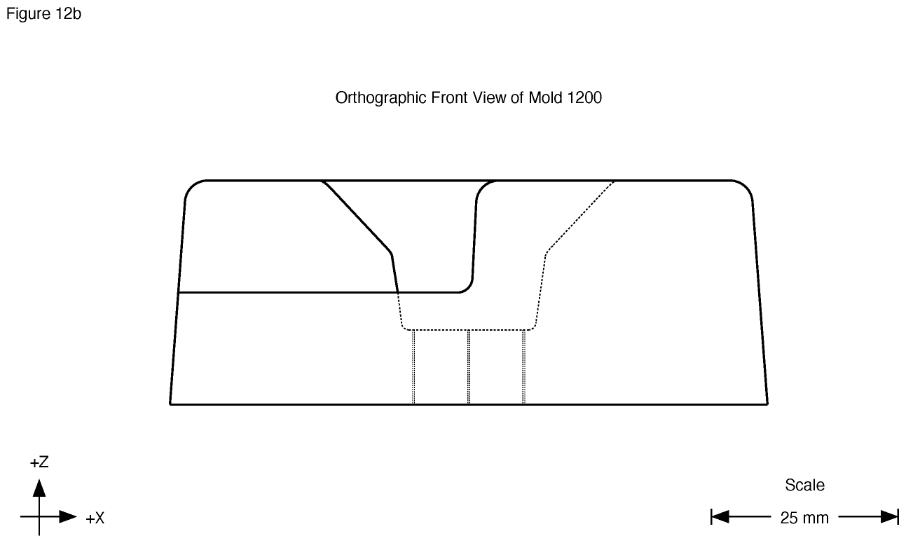

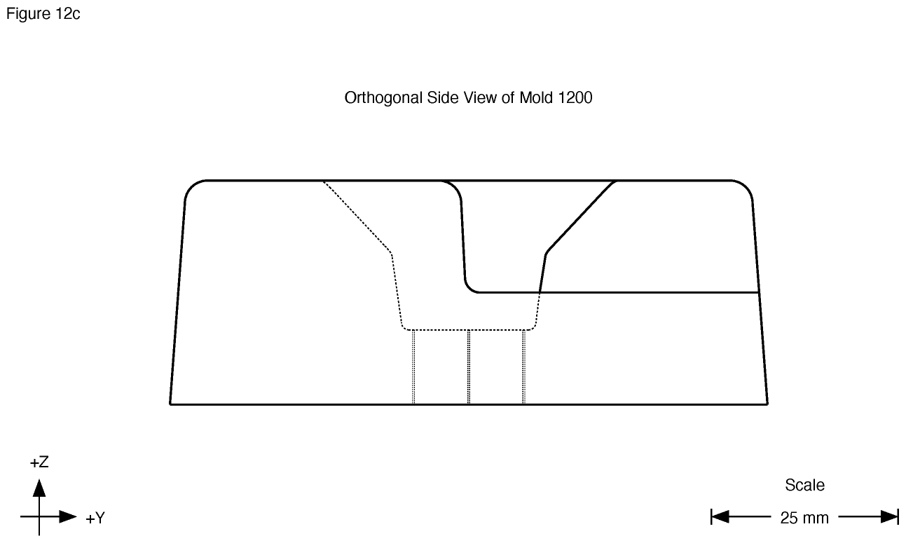

At task 103, the mold, post-processing die, and clamping frame for thermoforming the laminate designed in task 102 is designed and fabricated in well-known fashion. In accordance with the illustrative embodiment, the mold is a “male” mold, as shown in FIGS. 12a, 12b, and 12c, but it will be clear to those skilled in the art, after reading this disclosure, how to make and use alternative embodiments of the present invention in which a female or a hybrid mold is used.

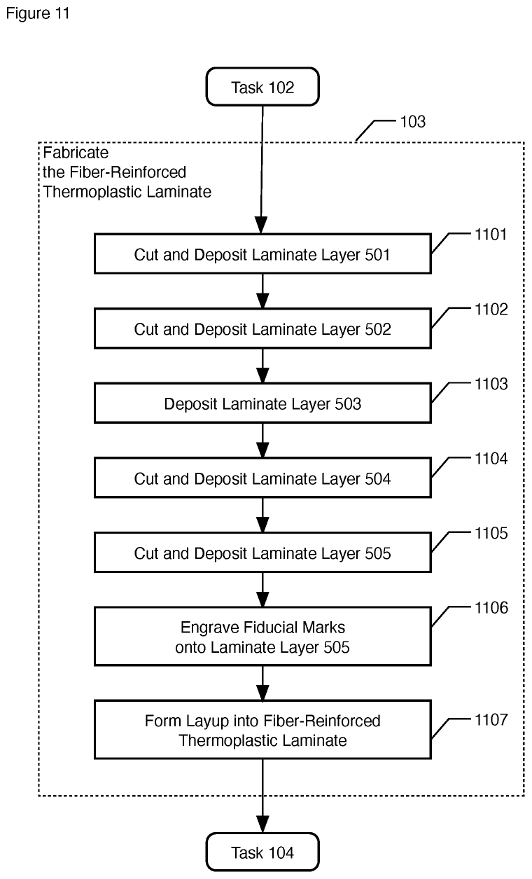

At task 104, the fiber-reinforced thermoplastic laminate that is designed in task 102 is fabricated. Task 104 is described in detail in FIG. 11 and the accompanying text.

At task 105, the article that is designed in task 101 is fabricated by thermoforming the fiber-reinforced thermoplastic laminate that was designed in task 102 and fabricated in task 104. It will be clear to those skilled in the art how to perform task 105.

At task 106, the article that was thermoformed in task 105 is post processed in accordance with the post-processing requirements to produce the finished article of manufacture. It will be clear to those skilled in the art how to perform task 106.

FIG. 3 depicts a flowchart of the salient tasks associated with task 102—designing the fiber-reinforced thermoplastic laminate from which cover 200 will be fabricated.

At task 301, an engineer with a computer-aided design system custom designs a fiber-reinforced thermoplastic laminate that will be thermoformed into cover 200. As part of this task, the engineer considers:
(i) the required geometry of the article in general, and, in particular, how the different portions of the laminate must stretch and be displaced to conform to the contour of the mold; and
(ii) the physical requirements of the article in general, and, in particular, whether the laminate will satisfy the physical requirements of the article after the laminate has been stretched and deformed; and
(iii) the economic requirements of the article; and
(iv) the post-processing requirements of the article
   to produce a complete specification of the laminate, which includes, among other things:
(i) a description of the overall dimensions of the laminate; and
(ii) a description of the number of layers that will compose the laminate; and
(iii) a description of whether each layer comprises:
   a full sheet of thermoplastic embedded with reinforcing fiber, or
   a full sheet of thermoplastic without reinforcing fiber, or
   a full sheet of reinforcing fiber without thermoplastic, or
   one or more patches of thermoplastic embedded with reinforcing fiber, or
   one or more patches of thermoplastic without reinforcing fiber, or
   one or more patches of reinforcing fiber without thermoplastic, or
   one or more metallic or plastic structural inserts.
(iv) a description of the overall dimensions and relative location of each piece in each layer; and
(v) for each piece that comprises a thermoplastic, a description of which thermoplastic(s) will compose that layer; and
(vi) for each piece that comprises reinforcing fiber, a description of the chemical makeup of the reinforcing fiber (e.g., carbon, glass, aramid, hemp, etc.); and
(vii) for each piece that comprises reinforcing fiber, a description of whether the reinforcing fiber are continuous or chopped; and
(viii) for each piece that comprises reinforcing fiber, a description of the number or density of the fibers; and
(ix) for each piece that comprises continuous reinforcing fiber, a description of whether the reinforcing fiber are unidirectional or multidirectional; and
(x) for each piece that comprises continuous reinforcing fiber, a description of the angular orientation of the fibers; and
(xi) for each piece that comprises continuous reinforcing fiber, a description of whether any continuous fibers are to be severed; and if so where the cuts should be; and
(xii) for each metallic or plastic structural insert, a description of its size, shape, location, and material composition.

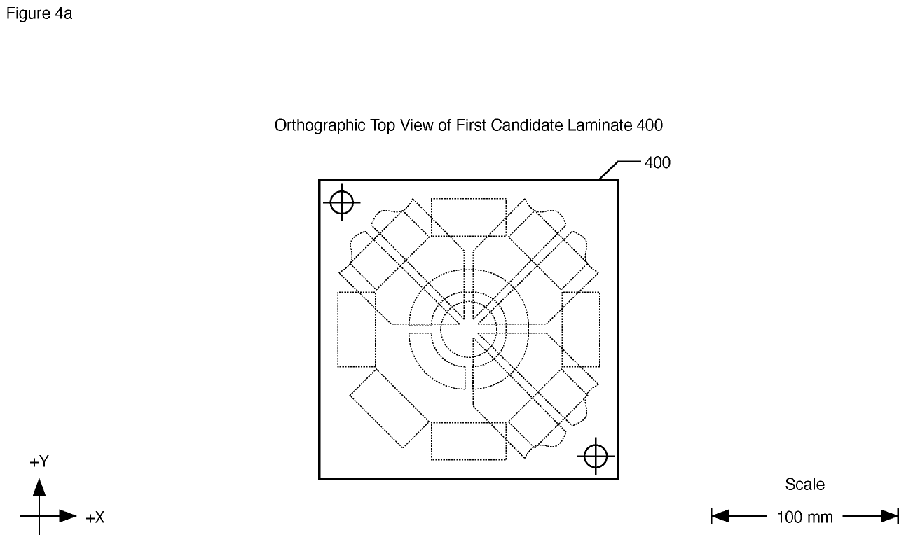

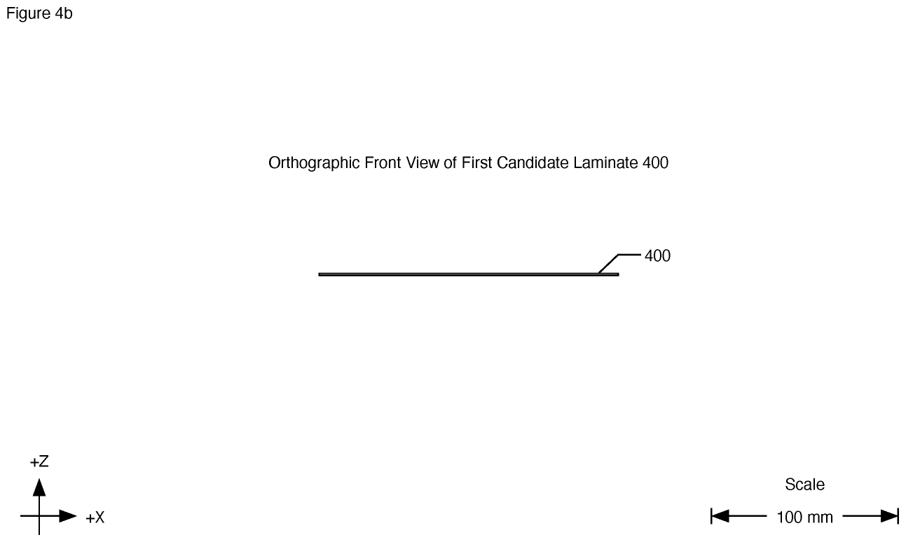

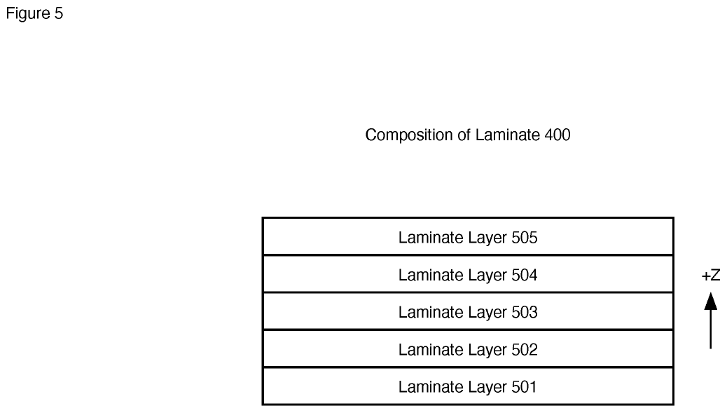

After considering these factors, the engineer produces a first design for the laminate—first candidate laminate 400. FIGS. 4a and 4b depict orthographic top and front views of first candidate laminate 400, and FIG. 5 depicts a schematic composition of the logical layers that compose first candidate laminate 400. With regard to a “layer,” the elements composing a layer are deposited during the creation of the layup after all of the elements of the “lower” layer are deposited and before any of the elements of the “upper” layer are deposited.

The overall dimensions of first candidate laminate 400 are 80.0 (Δx) by 80.0 mm (Δy) and has a thickness of 0.3 mm (Δz). It will be clear to those skilled in the art, after reading this disclosure, how to make and use alternative embodiments of the present invention of any dimension.

First candidate laminate 400 comprises five layers:
(i) laminate layer 501, and
(ii) laminate layer 501, and
(iii) laminate layer 503, and
(iv) laminate layer 504, and
(v) laminate layer 505.

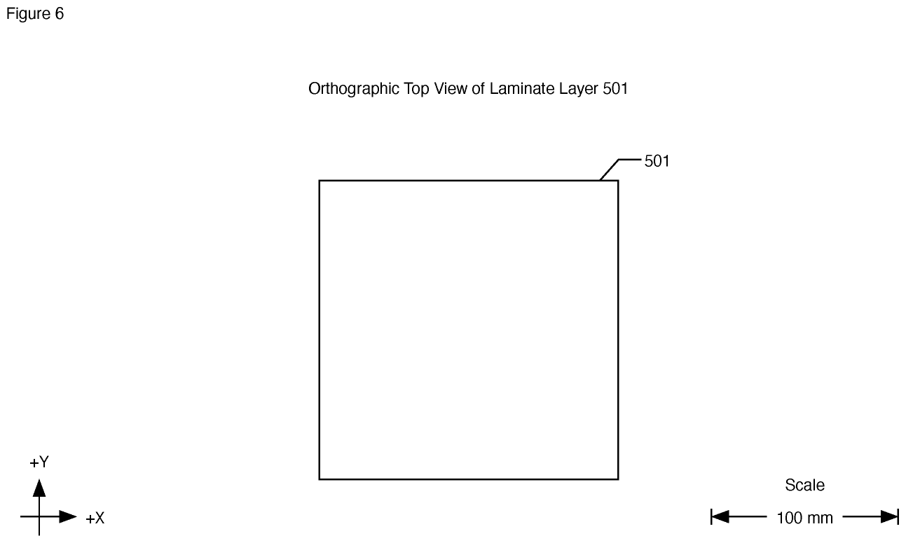

Laminate Layer 501—The principal purpose of laminate layer 501 is to provide bulk thermoplastic adjacent to laminate layer 501, and, therefore, laminate layer 501 is devoid of reinforcing fiber. FIG. 6 depicts an orthographic top view of laminate layer 501. Laminate layer 501 is 80.0 mm (Δx) by 80.0 mm (Δy) by 0.05 mm (Δz). Laminate layer 501 is composed entirely of polyethyletherketone (PEEK). In the process of forming the layup prior to consolidation, layer 501 is deposited first. It will be clear to those skilled in the art how to make laminate layer 501.

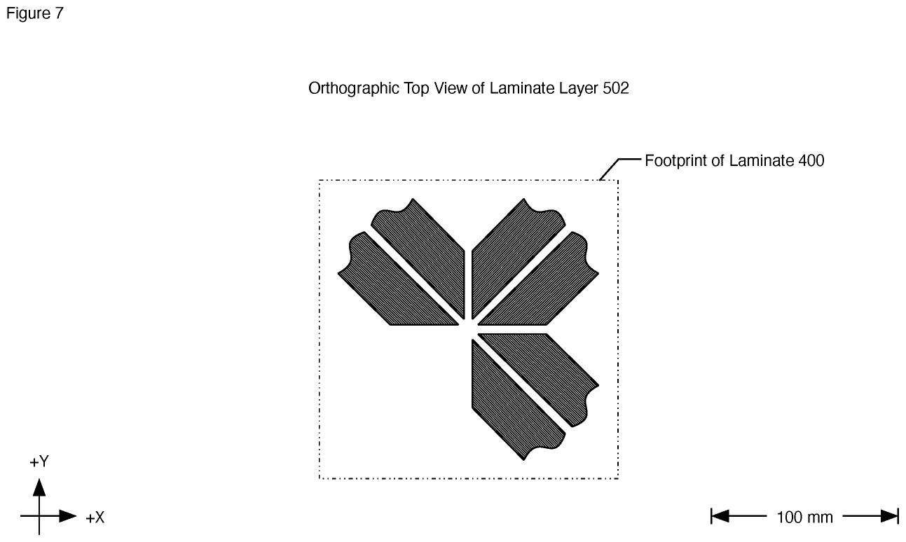

Laminate Layer 502—The principal purpose of laminate layer 502 is to provide radial tensile strength to cover 200. Because the principal purpose of laminate layer 502 is structural, it comprises six patches of thermoplastic that are each embedded with unidirectional continuous reinforcing fiber. FIG. 7 depicts an orthographic top view of laminate layer 502, which depicts the shape, location, and orientation of each of the six patches. Each patch is 0.1 mm thick (Δz) comprises uni-directional continuous carbon-fiber reinforcement that is wetted with, and embedded in, polyethyletherketone (PEEK). In the process of forming the layup, the six patches composing laminate layer 502 are deposited after and onto laminate layer 501. It will be clear to those skilled in the art how to make and use laminate layer 502.

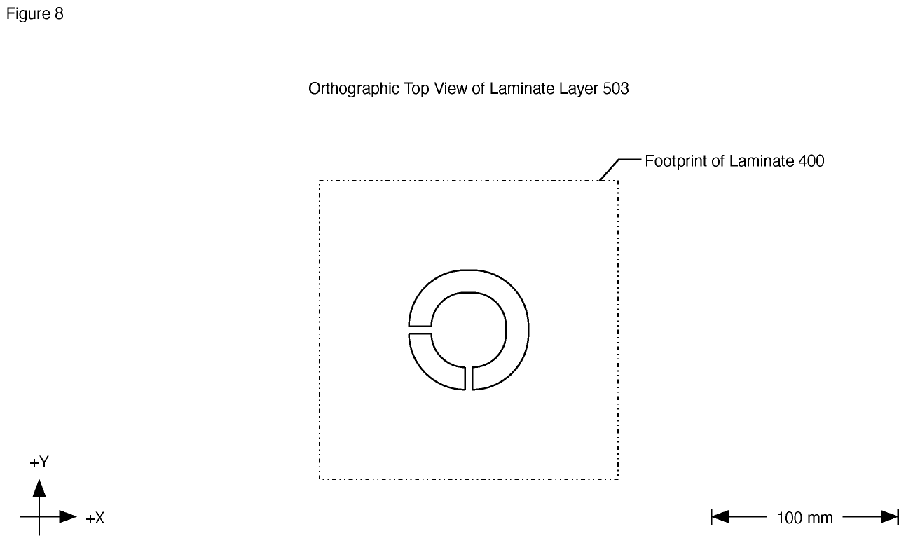

Laminate Layer 503—The principal purpose of laminate layer 503 is to provide rigidity and puncture resistance to portions of cover 200. Because the principal purpose of laminate layer 503 is structural, it comprises four segments of a metallic ring. FIG. 8 depicts an orthographic top view of laminate layer 503, which depicts the shape and location of the four segments. Each ring segment is made of 304 stainless steel and is 0.1 mm thick (Δz). In the process of forming the layup, the two ring segments are deposited after and onto the six patches of laminate layer 502. It will be clear to those skilled in the art how to make laminate layer 501.

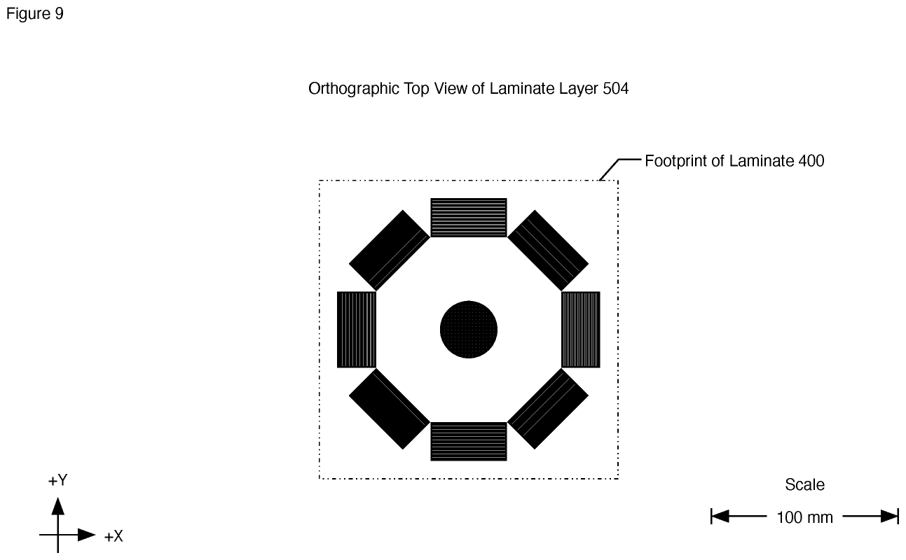

Laminate Layer 504—The principal purpose of laminate layer 504 is to provide circumferential tensile strength around the base of cover 200 and structural reinforcement in the center of cover 200. Because the principal purpose of laminate layer 504 is structural, it comprises nine patches of thermoplastic that are each embedded with unidirectional continuous reinforcing fiber. FIG. 9 depicts an orthographic top view of laminate layer 504, which depicts the shape, location, and orientation of each of the nine patches. Six patches are rectangular in shape, as shown in FIG. 8, and each comprises uni-directional continuous carbon-fiber reinforcement that is wetted with, and embedded in, polyethyletherketone (PEEK). One patch is circular in shape, as shown in FIG. 8, and comprises bi-directional continuous carbon-fiber reinforcement that is wetted with, and embedded in, polyethyletherketone (PEEK). All nine patches are 0.1 mm thick (Δz). In the process of forming the layup, the nine patches composing laminate layer 504 are deposited after and onto laminate layer 503, but as a practical matter the nine patches composing laminate layer 504 will rest at the same elevation as the two ring segments of laminate layer 503, all of which will rest on the six patches of laminate layer 502. It will be clear to those skilled in the art how to make and use laminate layer 504.

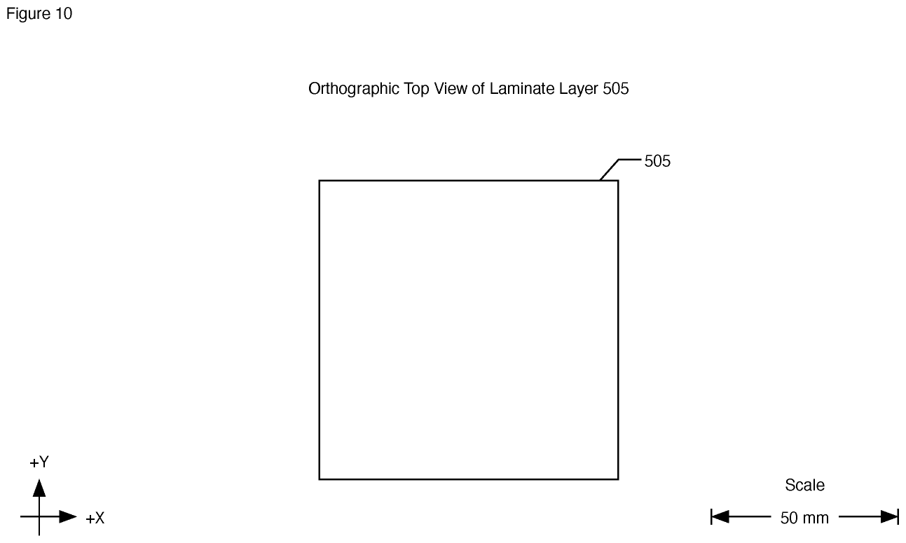

Laminate Layer 505—The principal purpose of laminate layer 505 is to provide bulk thermoplastic adjacent to laminate layer 504, and, therefore, laminate layer 505 is devoid of reinforcing fiber. FIG. 10 depicts an orthographic top view of laminate layer 505. Laminate layer 505 is 80.0 (Δx) by 80.0 mm (Δy) by 0.05 mm (Δz). Laminate layer 505 is composed entirely of polyethyletherketone (PEEK). In the process of forming the layup prior to consolidation, layer 505 is deposited after and onto laminate layer 504. It will be clear to those skilled in the art how to make laminate layer 505.

At task 302, the engineer determines if the article can be thermoformed from first candidate laminate 400 and if the resulting article will satisfy the required geometry of cover 200.

The process of thermoforming attempts to deform first candidate laminate 400—which is substantially planar—into cover 200—which is non-planar—using a vacuum and mold 1200, as shown in FIGS. 12a, 12b, and 12c. The process of deforming a substantially planar laminate into a non-planar article involves applying forces that cause portions of the laminate to stretch and be laterally displaced. The geometry of the article dictates the geometry of the molds, and the geometry of the molds dictates the location, direction, and magnitude of each of these forces.

In accordance with the illustrative embodiment, the engineer determines that the thermoforming of candidate laminate 400 on mold 1200 will result in an article that satisfies the geometric requirements of cover 200, and, therefore, control passes to task 303. In the counterfactual case where the thermoforming of candidate laminate 400 on mold 1200 will not result in an article that satisfies the geometric requirements of cover 200, control returns to task 301 where the first candidate laminate 400 will be redesigned. It will be clear to those skilled in the art how to perform task 302 on a candidate laminate.

At task 303, the engineer next determines if the article thermoformed from the second candidate laminate 900 will satisfy the physical requirements of cover 200, as specified in task 101. In accordance with the illustrative embodiment, the engineer accomplishes this by performing finite element analysis on a model of the laminate after it has been molded into the article considering which areas have fiber and which do not.

In accordance with the illustrative embodiment, the engineer determines that the thermoforming of candidate laminate 400 on mold 1200 will result in an article that satisfies the physical requirements of cover 200, and, therefore, control passes to task 304. In the counterfactual case where the thermoforming of candidate laminate 400 on mold 1200 will not result in an article that satisfies the physical requirements of cover 200, control returns to task 301 where the first candidate laminate 400 will be redesigned. It will be clear to those skilled in the art how to perform task 303 on a candidate laminate.

At task 304, the engineer determines if the article thermoformed from third candidate laminate 1500 will satisfy the economic requirements of cover 200, as specified in task 101. In accordance with the illustrative embodiment, the engineer determines that the thermoforming of candidate laminate 400 on mold 1200 will result in an article that satisfies the economic requirements of cover 200, and, therefore, control passes to task 103. In the counterfactual case where the thermoforming of candidate laminate 400 on mold 1200 will not result in an article that satisfies the economic requirements of cover 200, control returns to task 301 where the first candidate laminate 400 will be redesigned. It will be clear to those skilled in the art how to perform task 304 on a candidate laminate.

FIG. 11 depicts a flowchart of the salient subtasks associated with task 104—fabricating the fiber-reinforced thermoplastic laminate.

At task 1101, an 80.0 mm by 80.0 mm piece of 0.05 mm of unreinforced thermoplastic (i.e., laminate layer 501) is cut in well-known fashion, and deposited by robot. It will be clear to those skilled in the art, after reading this disclosure, how to make and use alternative embodiments of the present invention in which the thermoplastic is cut with a laser, knife, high-pressure waterjet, hot wire, or electric arc.

At task 1102, the six patches of fiber-reinforced thermoplastic (i.e., laminate layer 502) are cut in well-known fashion, deposited by robot onto the thermoplastic composing laminate layer 501 at the location and orientation shown in FIG. 7, and tacked in place to inhibit movement by bulk heating, spot welding, or induction heating in well-known fashion.

At task 1103, the two stainless steel ring segments (i.e., laminate layer 503) are deposited by robot onto the patches composing laminate layer 502 at the location and orientation shown in FIG. 8.

At task 1104, the six rectangular patches of fiber-reinforced thermoplastic (i.e., a portion of laminate layer 504) are cut in well-known fashion, deposited by robot onto the thermoplastic composing laminate layer 503 at the location and orientation shown in FIG. 9, and tacked in place to inhibit movement by bulk heating, spot welding, or induction heating in well-known fashion. Also, as part of task 1104, the one circular piece of fiber-reinforced thermoplastic (i.e., the remaining portion of laminate layer 504) is cut in well-known fashion, deposited onto the thermoplastic patch composing laminate layer 502 at the location and orientation shown in FIG. 9, and tacked in position to inhibit its movement.

At task 1105, an 80.0 mm by 80.0 mm piece of 0.05 mm of unreinforced thermoplastic (i.e., laminate layer 505) is cut in well-known fashion, heated until it is tacky, and deposited by robot.

At task 1106, a two-dimensional registration mark is added to two opposite corners of the laminate composing laminate layer 505, with an ink-jet printer, silk screen, or laser.

At task 1107, the layup assembled in tasks 1101 through 1105 is heated and pressed, in well-known form, into a fiber-reinforced thermoplastic laminate in preparation for task 105.

After reading this specification, it will be clear to those skilled in the art how to make and use alternative embodiments of the present invention that comprise:
(i) a laminate of any dimensions; and
(ii) a laminate that comprises any number of layers; and
(iii) a laminate in which each layer comprises:
   thermoplastic embedded with reinforcing fiber, or
   thermoplastic without reinforcing fiber, or
   reinforcing fiber without thermoplastic, or
   any number of patches, or
   any number of metal or plastic reinforcing and
(iv) a laminate in which each layer has any dimensions; and
(v) a laminate in which each layer that comprises thermoplastic comprises any thermoplastic(s); and
(vi) a laminate in which each layer that comprises reinforcing fiber comprises any type of fiber (e.g., carbon, glass, aramid, hemp, etc.); and
(vii) a laminate in which each layer that comprises reinforcing fiber comprises continuous or chopped fiber; and
(viii) a laminate in which each layer that comprises reinforcing fiber comprises any number or density of fibers; and
(ix) a laminate in which each layer that comprises continuous reinforcing fiber comprises unidirectional or multidirectional weaves, braids, tows, etc.; and
(x) a laminate in which each layer that comprises continuous reinforcing fiber, comprises continuous fibers at any angular orientation; and
(xi) a laminate that comprises any number or type metallic or thermoplastic inserts or reinforcements; and
(xiii) a laminate that comprises any number or size of thermoplastic patches.

In accordance with the illustrative embodiment, the candidate layers composed polyethyletherketone (PEEK), but it will be clear to those skilled in the art, after reading this disclosure, how to make and use alternative embodiments of the present invention that are composed of any thermoplastic (e.g., polyaryletherketone (PAEK), polyetherketoneketone (PEKK), polyetheretherketoneketone (PEEKK), polyetherketoneetherketoneketone (PEKEKK), polyamide (PA), polybutylene terephthalate (PBT), poly(p-phenylene sulfide) (PPS), etc. When the thermoplastic comprises a blend of an amorphous polymer with a semi-crystalline polymer, the semi-crystalline polymer can one of the aforementioned materials and the amorphous polymer can be a polyarylsulfone, such as polysulfone (PSU), polyethersulfone (PESU), polyphenylsulfone (PPSU), polyethersulfone (PES), or polyetherimide (PEI). In some additional embodiments, the amorphous polymer can be, for example and without limitation, polyphenylene oxides (PPOs), acrylonitrile butadiene styrene (ABS), methyl methacrylate acrylonitrile butadiene styrene copolymer (ABSi), polystyrene (PS), or polycarbonate (PC).

What is claimed is:

1. A method for fabricating a fiber-reinforced thermoplastic laminate, the method comprising:
assembling a first thermoplastic patch that is substantially planar onto a second thermoplastic patch that is substantially planar; and
consolidating the first thermoplastic patch and the second thermoplastic patch into a fiber-reinforced thermoplastic laminate.

2. The method of claim 1:
wherein the first patch comprises parallel reinforcing fibers in a first direction; and
wherein the second patch comprises parallel reinforcing fibers in a second direction; and
wherein the first direction is different than the second direction.

3. The method of claim 1:
wherein the first patch comprises a first shape; and
wherein the second patch comprises a second shape; and
wherein the first shape is different than the second shape.

4. The method of claim 1 further comprising:
cutting the first patch from a sheet of fiber-reinforced thermoplastic; and
cutting the second patch from the sheet of fiber-reinforced thermoplastic.

5. A fiber-reinforced thermoplastic laminate comprising:
a first layer of patches that comprises:
(i) a first thermoplastic patch that is substantially planar, and
(ii) a second thermoplastic patch that is substantially planar, wherein the first thermoplastic patch and the second thermoplastic patch are disjoint and do not overlap; and
a second layer of patches that comprises:
(i) a third thermoplastic patch that is substantially planar, and
(ii) a fourth thermoplastic patch that is substantially planar, wherein the third thermoplastic patch and the fourth thermoplastic patch are disjoint and do not overlap; and

6. The method of claim 5:
wherein the first patch comprises parallel reinforcing fibers in a first direction; and
wherein the second patch comprises parallel reinforcing fibers in a second direction; and
wherein the first direction is different than the second direction.

7. The method of claim 5:
wherein the first patch comprises a first shape; and
wherein the second patch comprises a second shape; and
wherein the first shape is different than the second shape.

8. An article of manufacture comprising:
a non-planar fiber-reinforced thermoplastic laminate that comprises:
(1) a first layer of patches that comprises:
(i) a first thermoplastic patch that is substantially planar, and
(ii) a second thermoplastic patch that is substantially planar, wherein the first thermoplastic patch and the second thermoplastic patch are disjoint and do not overlap; and
(2) a second layer of patches that comprises:
(i) a third thermoplastic patch that is substantially planar, and
(ii) a fourth thermoplastic patch that is substantially planar, wherein the third thermoplastic patch and the fourth thermoplastic patch are disjoint and do not overlap.

9. The method of claim 8:
wherein the first patch comprises parallel reinforcing fibers in a first direction; and
wherein the second patch comprises parallel reinforcing fibers in a second direction; and
wherein the first direction is different than the second direction.

10. The method of claim 8:
wherein the first patch comprises a first shape; and
wherein the second patch comprises a second shape; and
wherein the first shape is different than the second shape.

11. A method comprising:
cutting:
(i) a first thermoplastic patch that is substantially planar, and
(ii) a second thermoplastic patch that is substantially planar, wherein the second thermoplastic patch lies at least partially on the first thermoplastic patch; and
assembling and consolidating the first thermoplastic patch and the second thermoplastic patch into a fiber-reinforced thermoplastic laminate; and
thermoforming the fiber-reinforced thermoplastic laminate into an article of manufacture.

12. The method of claim 11:
wherein the first patch comprises parallel reinforcing fibers in a first direction; and
wherein the second patch comprises parallel reinforcing fibers in a second direction; and
wherein the first direction is different than the second direction.

13. The method of claim 12:
wherein the first patch comprises a first shape; and
wherein the second patch comprises a second shape; and
wherein the first shape is different than the second shape.
